(19) United States
(12) Patent Application Publication
(10) Pub. No.: US 2015/0112773 A1
(43) Pub. Date: Apr. 23, 2015

(54) FACILITATING ENVIRONMENT VIEWS EMPLOYING CROWD SOURCED INFORMATION

(71) Applicant: AT&T Intellectual Property I, LP, Atlanta, GA (US)

(72) Inventors: Behzad Shahraray, HOLMDEL, NJ (US); Lee Begeja, GILLETTE, NJ (US); David Crawford Gibbon, LINCROFT, NJ (US); Zhu Liu, MARLBORO, NJ (US); Bernard S. Renger, NEW PROVIDENCE, NJ (US); Eric Zavesky, AUSTIN, TX (US)

(73) Assignee: AT&T Intellectual Property I, LP, Atlanta, GA (US)

(21) Appl. No.: 14/058,558

(22) Filed: Oct. 21, 2013

(51) Int. Cl. H04L 29/08; G06Q 30/02

(52) U.S. Cl. CPC H04L 67/10; G06Q 30/0207
USPC 705/14.1; 709/201

(57) ABSTRACT

Facilitation of environment views employing crowd sourced information is provided. For example, an apparatus can determine a location of an environment of interest at a first defined time, and identify recording components proximate to the location substantially at the first defined time. The recording components can be communicatively coupleable to the apparatus. The apparatus can also request information from identified recording components, wherein the information is recorded by the recording components substantially at the first defined time, and stored at the recording components. The apparatus can receive the information from the identified recording components, and generate information indicative of a representation of an aspect of the environment substantially at the first defined time based on aggregating the received information.

### TECHNICAL FIELD

The subject disclosure relates generally to information processing, and specifically to facilitating environment views employing crowd sourced information.

### BACKGROUND

With an increase in the ability to gather data about events in our environment, the type and speed of communication transmission over wireless channels, and the desire to respond accordingly to such events, crowd sourcing has increased and the information obtained from crowd sourcing is in demand. However, current map services provide static views of the street/road and the surrounding areas. These views are often dated and do not reflect current road conditions.

### BRIEF DESCRIPTION OF THE DRAWINGS

FIG. 1 illustrates an example block diagram of a system facilitating environment views employing crowd sourced information from devices within a geographic range of an environment of interest in accordance with one or more embodiments described herein.

FIG. 2 illustrates an example location/direction time-date device information table of a controller of the system of FIG. 1 in accordance with one or more embodiments described herein.

FIG. 3 illustrates another example block diagram of the system of FIG. 1 facilitating environment views employing crowd sourced information outside of a geographic range of an environment of interest in accordance with one or more embodiments described herein.

FIG. 4 illustrates another example block diagram of the system of FIG. 1 facilitating environment views employing crowd sourced information utilizing incentivization in accordance with one or more embodiments described herein.

FIG. 5 illustrates an example block diagram of a controller that can facilitate environment views employing crowd sourced information in accordance with one or more embodiments described herein.

FIG. 6 illustrates an example block diagram of an incentivization determination component of the controller of FIG. 4 in accordance with one or more embodiments described herein.

FIG. 7 illustrates an example block diagram of an information processing component of the controller of FIG. 4 in accordance with one or more embodiments described herein.

FIG. 8 illustrates an example block diagram of data storage of the controller of FIG. 4 in accordance with one or more embodiments described herein.

FIG. 9 illustrates an example block diagram of a device that can facilitate environment views employing crowd sourced information in accordance with one or more embodiments described herein.

FIG. 10 illustrates an example block diagram of data storage of the device of FIG. 9 in accordance with one or more embodiments described herein.

FIGS. 11 and 12 illustrate example flowcharts of methods that facilitate environment views employing crowd sourced information in accordance with one or more embodiments described herein.

FIG. 13 illustrates a block diagram of a computer operable to facilitate environment views employing crowd sourced information in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this application, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (femto cell device),” “Node B,” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “mobile device,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies. Further, the term “femto” and “femto cell” are used interchangeably, and the terms “macro” and “macro cell” are used interchangeably.

Crowd sourced information has increased and continues to be on the rise due to efficiencies to be gained through the use of such information. As used herein, the term “crowd sourced information” means information gathered from one or more sources about an environment or event. As used herein, an “event” includes, but is not limited to, a weather-related event (e.g., an aspect of weather, tornado, snow storm, earthquake), a traffic-related event (e.g., a vehicle accident, heavy traffic congestion, construction, bridge out, parades, races, parties, sports-related events, road detours), a security- or fire- or other emergency-related event (e.g., burglary or fire at home or commercial residence, national or state security events, evacuations, public crime events) or the like.

Crowd sourced information can be utilized to inform users or systems located in a first geographic location of events in a second geographic location, wherein the second geographic location is distinct from the first location. Current map services provide views of the street and the surrounding environment. As used herein, a “street” is any paved or unpaved roadway connecting two points of interest to one another, and can include, but is not limited to, roadways facilitating traversing by pedestrian, non-motorized or motorized vehicle traffic, alleys, highways, underpasses or the like. These, however, are static views of the road obtained sometime in the past and stored for later access. Consequently, these views often do not reflect the current conditions of the road (e.g., traffic, weather, construction, parades, parties, races, flooding, accident etc.). Moreover, there is considerable effort, time, and cost associated with acquiring and storing such information.

Based on the foregoing, systems, methods, apparatus and/or computer-readable storage media described herein facilitate environment views employing crowd sourced information. In one embodiment, a method includes identifying, by a first device comprising a processor, a second device of devices associated with respective recording components, wherein the identifying is based on geographic locations of the devices and a location of an environment of interest. The method can also include transmitting, by the first device to a recording component of the respective recording components, a message indicative of a request for recorded information representing the location of the environment of interest, wherein the recording component is associated with the second device of the devices.

In another embodiment, another method includes receiving, by a first device comprising a processor, from a second device remote from the first device, a request for recorded information about an aspect of an environment, wherein the receiving is based on identification of the first device, by the second device, at a defined geographical location associated with the environment substantially at a defined time of interest. The method also includes transmitting, by the first device, to the second device, the recorded information, wherein the recorded information is stored at the first device.

In another embodiment, an apparatus includes: a memory to store executable instructions; and a processor, coupled to the memory, that facilitates execution of the executable instructions to perform operations. The operations include: determining a location of an environment of interest at a first defined time; identifying devices associated with respective recording components proximate to the location substantially at the first defined time, wherein the devices are communicatively coupleable to the apparatus; and requesting recorded information from identified devices, wherein the recorded information is recorded by the respective recording components substantially at the first defined time, and stored at the respective recording components.

One or more embodiments can advantageously provide a network connection between numerous disparate recording components and a central controller to allow recorded information about an environment of interest to be obtained dynamically and efficiently. One or more embodiments can also advantageously obtain information of interest through the use of incentivization for owners/devices that obtain the desired recorded information.

One or more embodiments can provide/update the current view of the environment (e.g., street) and/or provide/update event information. The information (and/or updates to the information) can be provided in real-time or near-real-time. Because the information is stored locally at recording components, embodiments described herein can also be used to provide visual information about an event after the event has transpired. For example, information about an accident, as seen from the cars that are involved and/or from the other cars in close proximity of the accident can be requested and viewed after the accident has transpired (notwithstanding the cars may be no longer at the location of the accident). The information from multiple recording components (e.g., car cameras), obtained at approximately the same time can be used to create enhanced views of the environment/area or views of the environment/area from different viewing points/perspectives.

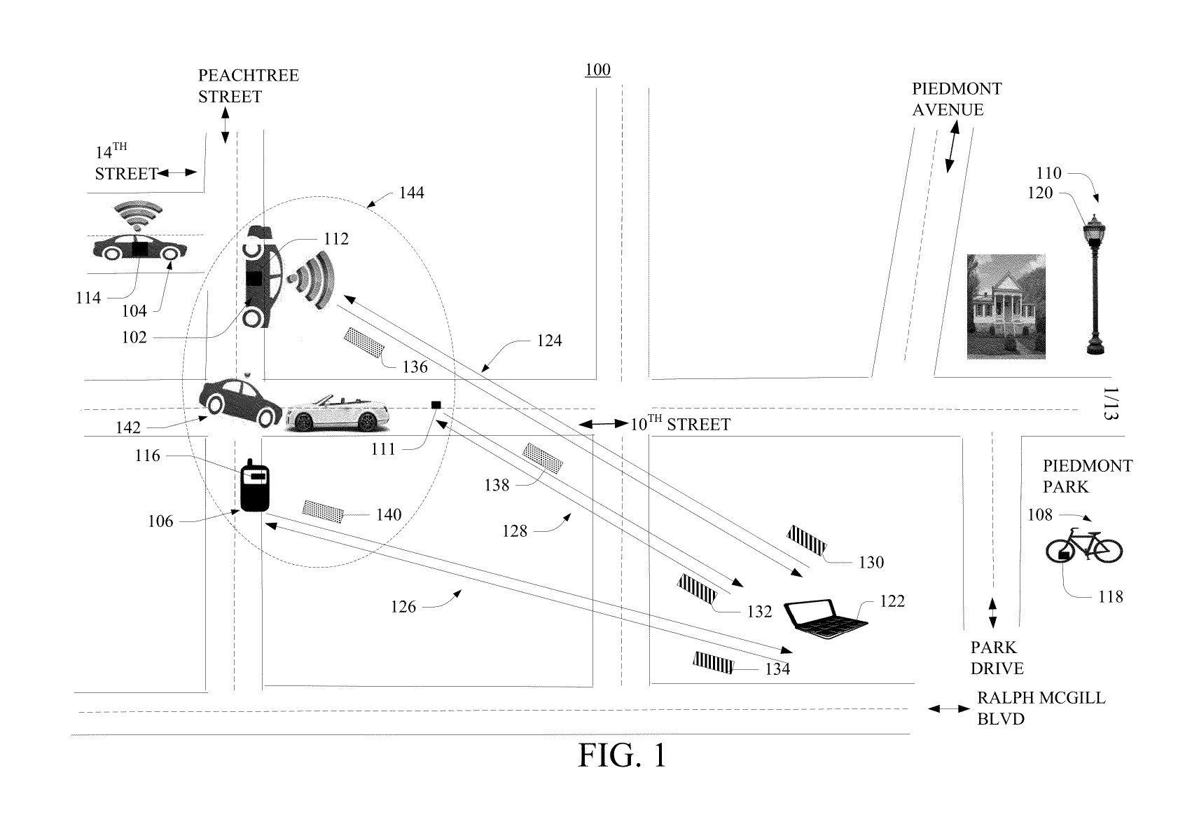

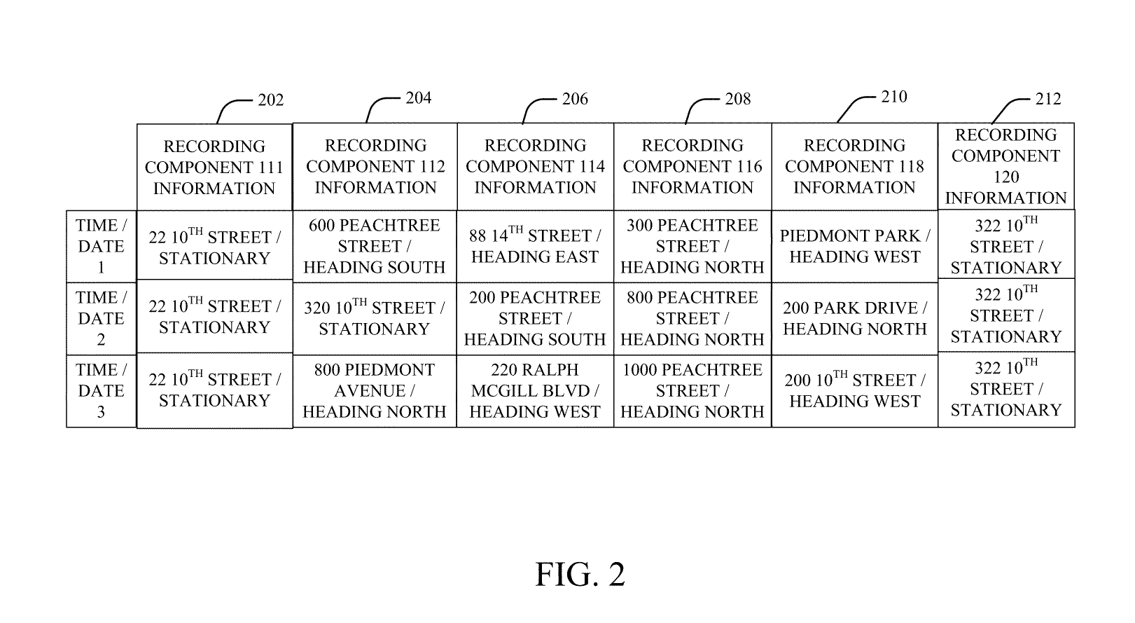

Turning now to the drawings, FIG. 1 illustrates an example block diagram of a system facilitating environment views employing crowd sourced information from devices within a geographic range of an environment of interest in accordance with one or more embodiments described herein. FIG. 2 illustrates an example location/direction time-date device information table of a controller of the system of FIG. 1 in accordance with one or more embodiments described herein.

Turning first to FIG. 1, system 100 can include one or more devices (e.g., devices 102, 104, 106, 108, 110), one or more recording components (e.g., recording components 112, 114, 116, 118, 120) and/or a controller (e.g., controller 122). Devices 102, 104, 106, 108, 110 and recording components 112, 114, 116, 118, 120 can be distributed over a geographical area that can include streets, parks, the sky, bodies of water or the like. Accordingly, a passive network of recording components 112, 114, 116, 118, 120 can be formed.

As shown, devices 102 can be mobile devices (e.g., connected cars 102, 104, mobile telephone 106, bicycle 108) in some embodiments, and can be stationary devices (e.g., light pole 110) in some embodiments. A “connected car” can mean a vehicle configured to access a network (e.g., internet or otherwise) and/or one or more other connected cars. In other embodiments, devices employed herein can include, but are not limited to, self-driving cars, personal computers, traffic lights, street signs, boats, helicopters, emergency vehicles (e.g., fire trucks, ambulances, police vehicles) or any number of different mobile or stationary devices.

While recording components 112, 114, 116, 118, 120 are electrically, mechanically and/or communicatively coupled to devices 102, 104, 106, 108, 110, in some embodiments, a recording component can be a stand-alone, self-powered device that is not coupled to any of devices 102, 104, 106, 108, 110. For example, in some embodiments, recording component 111 can be included in system 100. As shown, recording component 111 can be a stand-alone sensor fixed to street pavement. In other embodiments, recording component 111 can be positioned on architectural structures (e.g., buildings, bridges, overpasses), natural structures (e.g., trees) or any number of different types of mobile devices or stationary devices. For example, in some embodiments, recording component 111 can be positioned on a side of a motor vehicle (e.g., billboard of a truck).

Recording components 111, 112, 114, 116, 118, 120 can be any number of different types of devices configured to record information about an environment in which recording components 111, 112, 114, 116, 118, 120 are located. By way of example, but not limitation, recording components 111, 112, 114, 116, 118, 120 can be devices or sensors configured to record images, video, audio, temperature, atmospheric pressure, wind speed, humidity or any number of other aspects of an environment in which recording components 111, 112, 114, 116, 118, 120 are located. As such, recording components 111, 112, 114, 116, 118, 120 can be or include, but are not limited to, still picture cameras, video cameras, microphones, range-finding or depth-sensing apparatuses (e.g., radar), heads up displays (HUDs), augmented reality devices (e.g., GOOGLE® glass devices), audio recorders, thermometers, barometers, hygrometers, anemometers or the like.

In various embodiments, range-finding or depth-sensing devices can be any number of different types of devices that can sense/determine depth or distance between two objects (e.g., between recording components 111, 112, 114, 116, 118, 120 or devices 102, 104, 106, 108, 110 and another object/device located in the environment recorded by recording components 111, 112, 114, 116, 118, 120). Accordingly, determinations regarding objects in a street or identification of objects during nighttime conditions are facilitated.

In various embodiments, range-finding or depth-sensing devices can include, but are not limited to, laser-based devices (e.g., lidar), devices that employ radio waves for sensing/determination (e.g., radar) or devices that employ active infrared projection for sensing/determination. For example, recording components 111, 112, 114, 116, 118, 120 can be configured to record both visible light and information indicative of a response of an infrared projection pattern to determine the depth and/or shape of devices/objects in view. As another example, recording components 111, 112, 114, 116, 118, 120 can be configured to perform distance approximation.

In various embodiments, recording components 111, 112, 114, 116, 118, 120 can be any devices including software, hardware or a combination of hardware and software configured to communicate recorded information about the environment surrounding recording components 111, 112, 114, 116, 118, 120 to controller 122. In some embodiments, recording components 111, 112, 114, 116, 118, 120 communicate directly via wired or wireless channels with controller 122 while, in other embodiments, recording components 111, 112, 114, 116, 118, 120 can communicate with controller 122 via communication components (e.g., transceivers) of devices 102, 104, 106, 108, 110 to which recording components 111, 112, 114, 116, 118, 120 can be electrically and/or communicatively coupled.

In various embodiments, recording components 111, 112, 114, 116, 118, 120 and/or devices 102, 104, 106, 108, 110 have opted to be included in a network accessed by controller 122 to provide recorded information to controller 122 and/or receive requests for recorded information from controller 122.

The recorded information recorded by recording components 111, 112, 114, 116, 118, 120 can be stored locally at memory of or associated with recording components 111, 112, 114, 116, 118, 120 (or at memory of or associated with devices 102, 104, 106, 108, 110).

In some embodiments, various details or information associated with or included within recorded information can be removed/extracted such that the recorded information stored at recording components 111, 112, 114, 116 118, 120 and/or transmitted to controller 122 is anonymized. By way of example, but not limitation, anonymized recorded information can be recorded information having information other than time and location of the recording removed. By way of another example, anonymized recorded information can be information having details regarding the source of the recorded information removed. In one embodiment, the recorded information can be anonymized after undergoing authentication to reduce the likelihood that fake/non-real-time data is injected into the recorded information. While the above embodiments describe anonymizing recorded information, in other embodiments, the recorded information need not be anonymized and the entirety of information can be stored at recording components 111, 112, 114, 116 118, 120 and/or transmitted to controller 122.

Recorded information recorded over any number of different time periods (e.g., days, weeks, months) can be stored at recording components 111, 112, 114, 116, 118, 120 or devices 102, 104, 106, 108, 110 until requested by controller 122. Upon request by controller 122, recorded information can be transmitted to controller 122. Accordingly, embodiments described herein can facilitate local, distributed storage of recorded information to minimize the amount of data traffic communicated over channels and/or to minimize the amount of data storage required to be stored at controller 122.

In some embodiments, to facilitate long-term retention and distribution, recorded information from any of recording components 111, 112, 114, 116, 118, 120 and/or the devices 102, 104, 106, 108, 110 can be copied to a network storage or other device within the network including a fixed device (e.g., device 110), controller 122 or a mobile device (e.g., device 114), and deleted from local storage at the recording component that recorded the recorded information, with no loss of information. Such can be performed as determined by the needs of the recording component and/or the network.

Controller 122 can be any device having hardware, software or a combination of hardware and software configured to perform any number of different functions including, but not limited to, updating information associated with previously-generated environment views (in real-time or non-real-time); generating new environment views (in real-time or non-real-time); summarizing or incorporating generated environment views into other information representations (e.g., summarizing or incorporating video or image views into textual descriptions or numerical statistics) at various time intervals and initial periods; identifying devices 102, 104, 106, 108, 110 or recording components 111, 112, 114, 116, 118, 120 associated with geographic locations (either currently or in the past) of environments of interest; requesting recorded information for an environment of interest from devices 102, 104, 106, 108, 110 or recording components, 111, 112, 114, 116, 118, 120; determining incentivization information to incentivize devices 102, 104, 106, 108, 110 to travel to geographical locations of environments of interest to recorded information about the environment of interest; causing recording components, 111, 112, 114, 116, 118, 120 to power on to allow recording components 111, 112, 114, 116, 118, 120 to record an environment or transmit recorded information to controller 122; causing recording components 111, 112, 114, 116, 118, 120 to power off; transmitting incentivization information to devices 102, 104, 106, 108, 110 and/or recording components 111, 112, 114, 116, 118, 120; brokering a fee between a third-party requesting recorded information and one or more of devices 102, 104, 106, 108, 110 or recording components 111, 112, 114, 116, 118, 120 providing recorded information for the third-party; and/or facilitating receipt of requests for recorded information from third-parties.

In the embodiment shown in FIG. 1, devices 102, 104, 106, 108, 110 are electrically and/or communicatively coupled to respective recording components 112, 114, 116, 118, 120 while recording component 111 is a stand-alone recording device. As shown, recording components 112, 116 are located on a first street, recording component 111 is located on a second street, recording component 114 is located on a third street, and recording component 120 is located near a fourth street, and recording component 118 is located in a park (and may or may not be located on a street, on grass or any number of different areas within the park).

Recording components 111, 112, 114, 116, 118, 120 can record image, video, audio, temperature, humidity, air pressure and/or wind speed information about the environments in geographic proximity to recording components 112, 114, 116, 118, 120. The geographic proximity over which information can be recorded can vary based on the type of information being recorded. For example, for recordation of video information, the geographic range determined to be within geographic proximity of an environment can be limited by the capacity of the camera of the video recorder while, for recordation of air pressure, the geographic range determined to be within geographic proximity of an environment can be limited to physical principles of air pressure and the distance at which a measurement can be obtained within a range of defined accuracy.

In some embodiments, the location of an event (e.g., event 142) can determine an environment of interest. For example, for event 142, the environment of interest can be the surrounding environment defined by geographical range 144. While event 142 is shown as a vehicular accident, in various embodiments, event 142 can be, but is not limited to, construction, traffic detours, parades, races, parties, sports-related events, traffic congestion or the like. In some embodiments, event 142 need be only a location of an environment of interest. For example, event 142 can be a location for which controller 122 would like to obtain new or updated environment information. By way of example, but not limitation, the updated information can be desired for generating and/or updating environment (e.g., street) views, mapping, textual or numerical summaries or the like.

Controller 122 can determine that information about event 142 is desired. In some embodiments, controller 122 can determine that information about event 142 is desired based on receipt of a request for recorded information about event 142 from a third-party (e.g., pedestrian, driver, law enforcement involved in event 142). Although the embodiment in FIG. 1 shows an automobile accident and describes a third-party request for information, in other embodiments, controller 122 can determine that information about a weather event, construction event, traffic event or other type of event (e.g., parades, races, parties, sports-related event) is desired.

Controller 122 stores location-time-date information about devices 102, 104, 106, 108, 110 and/or recording components 111, 112, 114, 116, 118, 120 (e.g., geographic location; direction of travel of devices 102, 104, 106, 108, 110 and/or recording components 111, 112, 114, 116, 118, 120; time and date at which devices 102, 104, 106, 108, 110 and/or recording components 111, 112, 114, 116, 118, 120 were at various different geographic locations).

In some embodiments, global positioning system (GPS) location information and information regarding the direction of travel of devices 102, 104, 106, 108, 110 and/or recording components 111, 112, 114, 116, 118, 120 (or the direction in which devices 102, 104, 106, 108, 110 and/or recording components 111, 112, 114, 116, 118, 120 are headed) can be determined or known to controller 122 via a network-based service and/or via information received from polling devices 102, 104, 106, 108, 110 and/or recording components 111, 112, 114, 116, 118, 120. The location-time-date information stored by controller 122 can be updated from time to time. Further, in various embodiments, controller 122 can access the location-time-date information to determine the current and/or past geographic locations of devices 102, 104, 106, 108, 110 and/or recording components 111, 112, 114, 116, 118, 120.

An example of stored location/direction time-date device information table of a controller of the system of FIG. 1 in accordance with one or more embodiments described herein. Repetitive description of like elements employed in respective embodiments of systems and/or apparatus described herein are omitted for sake of brevity.

Identification information for recording components 111, 112, 114, 116, 118, 120 are shown at 202, 204, 206, 208, 210, 212. Controller 122 maintains information about the geographical location and direction of travel of recording components 111, 112, 114, 116, 118, 120 at different points in time and/or on different dates. For example, time/date 1 shows the set of locations of recording components 111, 112, 114, 116, 118, 120 in FIG. 1. Recording component 111 is located at 22 10^{th} Street and is stationary (because recording component 111 is a sensor fixed to street pavement). Recording component 112 is located at 600 Peachtree Street and is heading south, recording component 114 is located at 88 14^{th} Street and is heading east, recording component 116 is located at 300 Peachtree Street and is heading north, recording component 118 is located in Piedmont Park and is heading west and recording component 120 is located at 322 10^{th} Street and is stationary (because recording component 120 is fixed to a light pole).

As such, controller 122 can reference the stored location-time-date information and determine which of devices 102, 104, 106, 108, 110 and/or recording components 111, 112, 114, 116, 118, 120 are within geographic range 144. Controller 122 can determine that recording components 111, 112 and 116 are each within environment 144 and in geographic proximity of event 142. By contrast, controller 122 can determine that recording components 120, 118 are not within environment 144 and/or geographic proximity to event 142.

As shown in FIG. 1, controller 122 can transmit, via wireless channels 124, 128, 126, messages 130, 132, 134 to recording components 112, 116, 111 (and/or devices 102, 106 and recording component 111).

In some embodiments, messages 130, 132, 134 can cause recording components 111, 112, 116 to power on to record environment 144 and/or event 142. Accordingly, in some embodiments, recording components 111, 112, 116 can be remotely activated by controller 122. A network-based service (not shown) can be employed to cause the information output by controller 122 to remotely activate recording components 111, 112, 116 in some embodiments.

In some embodiments, messages 130, 132, 134 can include information requesting recorded information for environment 144 and/or event 142 (and/or otherwise causing recorded information to be transmitted to controller 122 from devices 102, 106 and/or recording components 111, 112, 116). The messages 130, 132, 134 can include information including, but not limited to, the geographic location of environment 144 and/or event 142, a defined time of interest for recording the recorded information, a defined date of interest of recorded information or the like. As such, controller 122 can specify a time and/or date for which the recorded information should be captured. As such, real-time capture can be facilitated, future recordation can be scheduled in advance of the event and/or past events previously-recorded can all be requested in various embodiments described herein.

In some embodiments, messages 130, 132, 134 can include information indicative of a desired point, tilt and/or zoom of one or more of recording components 111, 112, 116. Accordingly, controller 122 can transmit information indicative of a manner of controlling optical focus and/or view configuration of recording components 111, 112, 116.

Devices 102, 106 and/or recording components 111, 112, 116 can transmit recorded information 136, 138, 140 to controller 122 about environment 144 and/or event 142 in response to messages 130, 132, 134. In some embodiments, in addition to recorded information, devices 102, 106 and/or recording components 111, 112, 116 can transmit to controller 122 information about a point, tilt and/or zoom of recording component (e.g., recording components 111, 112, 116) when recorded information 136, 138, 140 was generated to allow controller 122 to aggregate different recorded information 136, 138, 140 from different angles and locations within environment 144 relative to the locations and/or angle of other recorded information 136, 138, 140.

While the embodiments describe numerous different wireless channels 124, 126, 128, wireless channels 124, 126, 128 can be the same or different wireless channels. Further, in various embodiments, wireless channels 124, 126, 128 can be or operate according to any number of different wireless communication protocols.

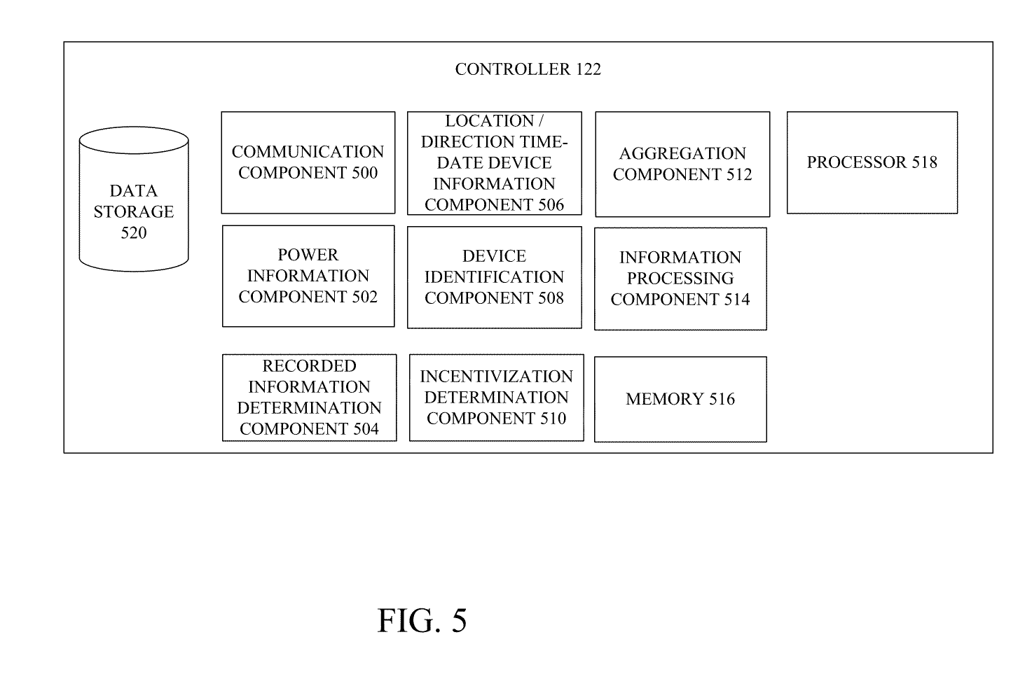

The structure and/or functionality of controller 122 will be described in greater detail with reference to FIGS. 5, 6, 7 and 8. However, it is noted that, in various embodiments, controller 122 can receive recorded information 136, 138, 140 and perform image or signal processing on recorded information 136, 138, 140. For example, controller 122 can generate a map, data or imagery indicative of the recorded information provided. By way of example, but not limitation, controller 122 can generate a view based on one of the recorded information 136, 138, 140 (or a portion of recorded information 136, 138, 140) received and/or based on a combination of recorded information 136, 138, 140 (or portions of recorded information 136, 138, 140). By way of example, but not limitation, controller 122 can generate an environment view (e.g., street view, park view), panoramic view, stereoscopic view, map, image information, map information, temperature information or charts, humidity information or charts or any of a number of various information shown graphically, via imagery, via video, textually or the like. For example, in some embodiments, controller 122 can include structure to perform one or more additional advanced processing techniques from computer vision, and computational photography to combine information from multiple recording components to create enhanced views of the area (e.g., larger coverage, multiple view points, improved image quality, etc.). In some embodiments, controller 122 can combine views in recorded information 136, 138, 140 from multiple recording components 112, 111, 116 for better viewpoint of a single location or event.

In various embodiments, controller 122 can transmit the generated information to an information repository (e.g., database for map/navigation websites) and/or to a third-party that has requested the recorded information. In some embodiments, the recorded information retrieved by controller 122 can be accessed and/or received by one or more different entities providing security information (e.g., password, pre-authenticated security token) allowing the entity to access controller 122 and/or receive recorded information from controller 122. In some embodiments, law enforcement or emergency services can access and/or receive recorded information from controller 122 to sample from recording components 111, 112, 116 since recording components 111, 112, 116 are in the vicinity of environment 144/event 142.

While the embodiments described above detail recorded information being received by controller 122, in some embodiments, controller 122 can facilitate third-party direct access to the recorded information from recording components 111, 112, 116 in lieu of receipt of the recorded information by controller 122. In these embodiments, a device associated with or located at a third-party requesting recorded information can receive the recorded information from recording components 111, 112, 116.

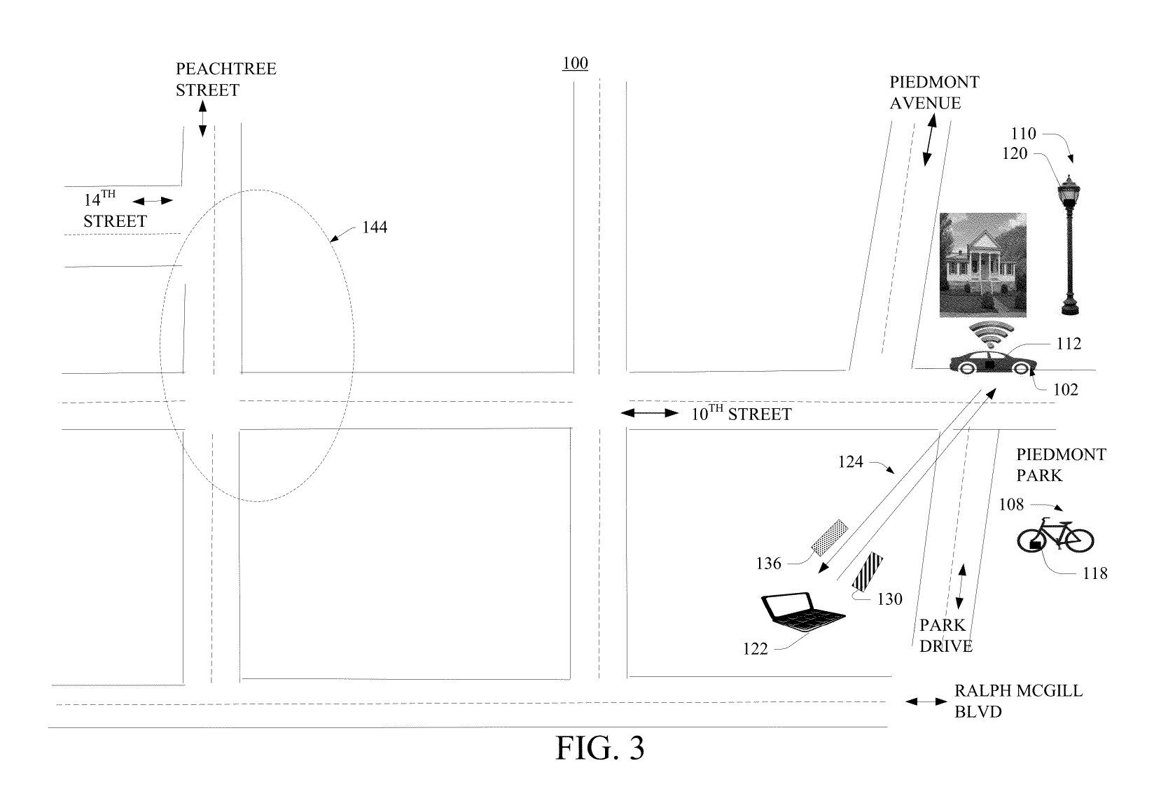

FIG. 3 illustrates another example block diagram of the system of FIG. 1 facilitating environment views employing crowd sourced information outside of a geographic range of an environment of interest in accordance with one or more embodiments described herein. Repetitive description of like elements employed in respective embodiments of systems and/or apparatus described herein are omitted for sake of brevity.

In FIG. 3, controller 122 has identified environment 144 to be of interest. As described with reference to FIGS. 1 and 2, controller 122 can identify a time and/or date for which recorded information is desired for environment 144.

After identifying environment 144 and a defined time and/or date of interest, controller 122 can reference location/direction time-date device information shown in FIG. 2 to identify which of devices 102, 104, 106, 108, 110 and/or recording components 111, 112, 114, 116, 118, 120 were at environment 144 substantially at the defined time and/or date of interest. As an example, controller 122 can determine that device 102 and/or recording component 112 were within environment 144 substantially at the defined time and/or date of interest. By contrast, controller 122 can determine that recording components 120, 118 were not within environment 144 substantially at the defined time and/or date of interest.

Controller 122 can transmit, via wireless channel 124, message 130 to recording component 112 (and/or device 102) to request recorded information for environment 144 and the defined time and/or date of interest. For example, recorded information 136 can be recorded information from environment 144 substantially at the defined time and/or date of interest specified in message 130.

As shown in FIG. 3, recording component 112 need not be at environment 144 at the time of receipt of message 130. By contrast, recording component 112 can be located outside of environment 144 substantially at the time of the transmission of message 130 from controller 122. However, controller 122 can access data storage information identifying that device 102 and/or recording component 112 was located within environment 144 during the defined time and/or date of interest and transmit message 130.

In some embodiments, message 130 can cause recording component 112 and/or device 102 to power on recording component 112 to transfer recorded information 136. In various embodiments, recording component 112 can store recorded information in smaller continuous files separated by time segments and/or date segments. As such, recording component 112 can transfer the requested segment to controller 122. Accordingly, embodiments described herein can retrieve recorded information recorded in the past for use by controller 122 and/or a third-party entity.

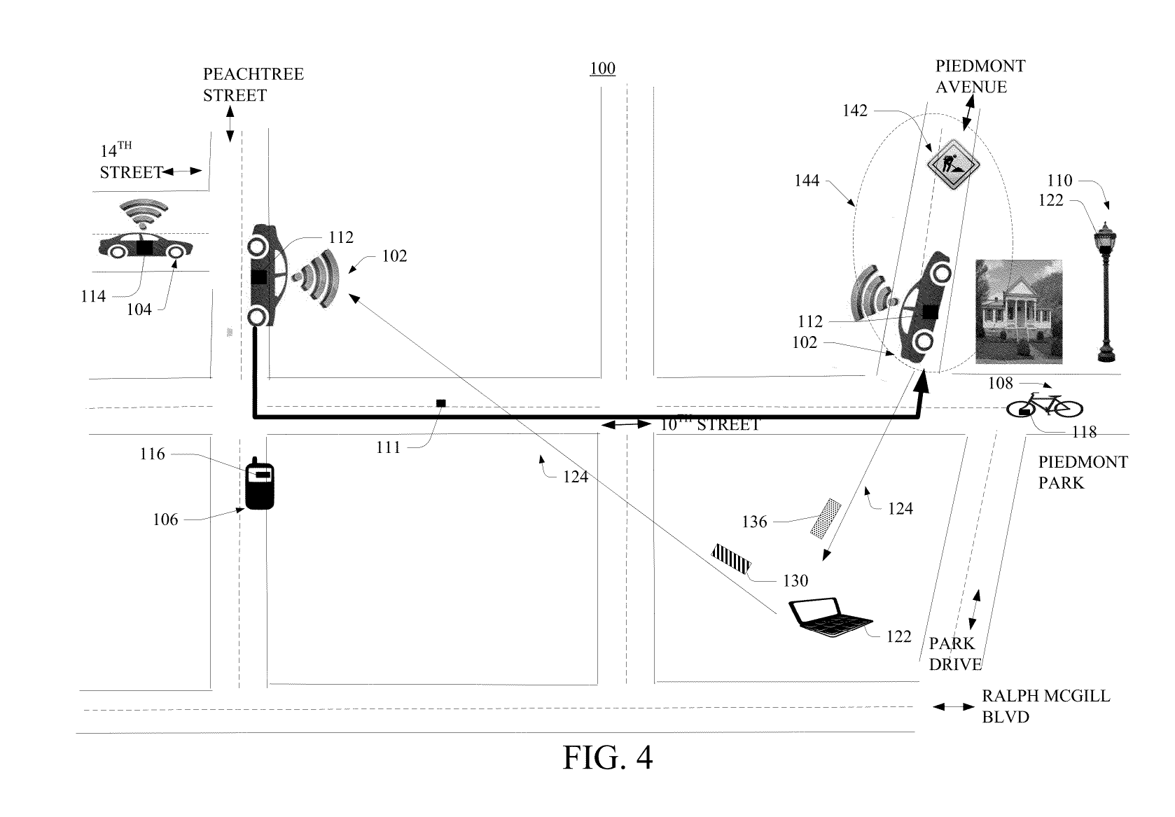

FIG. 4 illustrates another example block diagram of the system of FIG. 1 facilitating environment views employing crowd sourced information utilizing incentivization in accordance with one or more embodiments described herein. Turning now to FIG. 4, in various embodiments, controller 122 can generate and/or determine incentivization information to transmit to a device or recording component to attempt to incentivize the device to travel to an environment of interest for recordation of information at the environment.

By way of example, but not limitation, controller 122 can determine that recorded information is desired about event 142 (e.g., construction) in environment 144. In various embodiments, based on information retrieved from the device information table shown in FIG. 2, controller 122 can determine that no devices and/or recording components are in environment 144. Accordingly, controller 112 can generate incentivization information for device 102 and/or recording component 112 to drive from Peachtree Street to environment 144 on Piedmont Avenue to obtain recorded information about event 142. In various embodiments, the incentivization information can be any of a number of different types or amounts of incentives. For example, in some embodiments, incentivization information can be or include monetary compensation, points or other rewards (e.g., coupons) that can be exchanged for products or services, discounts off billing or otherwise.

In some embodiments, incentivization information can include information about compensation offered by a third-party that requests the recorded information. In this regard, controller 122 can serve as a broker between the device or recording component that obtains the recorded information and/or a third-party that requests the recorded information. By way of example, but not limitation, the third-party can be or include a human entity or a business entity that has an interest in the environment at a defined time. The defined time can be the current time, a time in the past or a future time. In some embodiments, the defined time can be a time associated with an event that has occurred or has not occurred. For example, in one embodiment, a driver that was involved in a vehicular accident in the past can request recorded information for time, date and/or geographical location of the event to attempt to obtain views of the accident.

As another example, a news entity (e.g., television or radio news entity) can request recorded information to provide an on-the-spot report of an event that is ongoing, has occurred or may occur in the future. If the event occurs, and controller 122 becomes aware of the event, controller 122 can transmit a message to cause a recording component to be an on-the-spot reporter of the event. If the event has occurred, controller 122 can receive a request from the entity and cause a device to travel to the location of the event to be an on-the-spot reporter of the event. In various embodiments, on-the-spot reporting can be useful for example, when a live newscast is desired and/or in environments in which the level of danger or inconvenience to a reporter may be too great to warrant sending a reporter to the location (but devices already present can be utilized for retrieval of information). For example, recorded information from recording components located in environments at which thunderstorms, tornados or hurricanes may be ongoing can be retrieved. Structure and/or functionality of controller 122 for generation of incentivization information can be as described in greater detail with reference to FIGS. 5, 6 and 7.

FIG. 5 illustrates an example block diagram of a controller (e.g., controller 122) that can facilitate environment views employing crowd sourced information in accordance with one or more embodiments described herein. Controller 122 can include communication component 500, power information component 502, recorded information determination component 504, location/direction time-date device information component 506, device identification component 508, incentivization determination component 510, aggregation component 512, information processing component 514, memory 516, processor 518 and/or data storage 520.

In various embodiments, one or more of communication component 500, power information component 502, recorded information determination component 504, location/direction time-date device information component 506, device identification component 508, incentivization determination component 510, aggregation component 512, information processing component 514, memory 516, processor 518 and/or data storage 520 can be electrically and/or communicatively coupled to one another to perform one or more functions of controller 122. Repetitive description of like elements employed in respective embodiments of systems and/or apparatus described herein are omitted for sake of brevity.

Communication component 500 can transmit and/or receive information including, but not limited to, video, images, text or the like. For example, communication component 500 can transmit a message to one or more devices (e.g., device 102, 104, 106, 108, 110) or recording components (e.g., recording components 111, 112, 114, 116, 118, 120) requesting recorded information associated with a desired geographical location, time and/or date. Communication component 500 can receive from one or more devices, the requested recorded information.

Power information component 502 can determine whether to turn on or turn off a recording component. For example, if a particular recording component is identified by device identification component 508 as being a device from which recorded information should be retrieved, power information component 502 can transmit a message to the device, or recording component of the device, to cause the recording component to power on. Similarly, power information component 502 can transmit a message to cause a recording component to power off. In various embodiments, the information output by power information component 502 can facilitate powering on/off a recording component via a network-based service.

Recorded information determination component 504 can determine recorded information to request from one or more devices. For example, with reference to FIG. 1, if a third-party requests recorded information about event 142, recorded information determination component 504 can determine information associated with such event (e.g., environment of event 142, defined time and/or date of event 142) and communication component 500 can transmit a message requesting the recorded information.

Location/direction time-date device information component 506 can store and update the location, direction of travel, time and/or date of the one or more devices or recording components. For example, location/direction time-date device information component 506 can store and/or update information such as that shown in FIG. 2.

Device identification component 508 can identify a device or recording component associated with a desired event, environment, time and/or date. For example, device identification component 508 can access information indicative of the location of the devices and/or recording components at different times and/or dates and identify a device and/or recording component from which to request recorded information.

In some embodiments, various details or information associated with or included within recorded information can be removed/extracted such that the recorded information stored at recording components 111, 112, 114, 116 118, 120 and/or transmitted to controller 122 is anonymized. By way of example, but not limitation, anonymized recorded information can be recorded information having information other than time and location of the recording removed. By way of another example, anonymized recorded information can be information having details regarding the source of the recorded information removed. In one embodiment, the recorded information can be anonymized after undergoing authentication to reduce the likelihood that fake/non-real-time data is injected into the recorded information. While the above embodiments describe anonymizing recorded information, in other embodiments, the recorded information need not be anonymized and the entirety of information can be stored at recording components 111, 112, 114, 116 118, 120 and/or transmitted to controller 122.

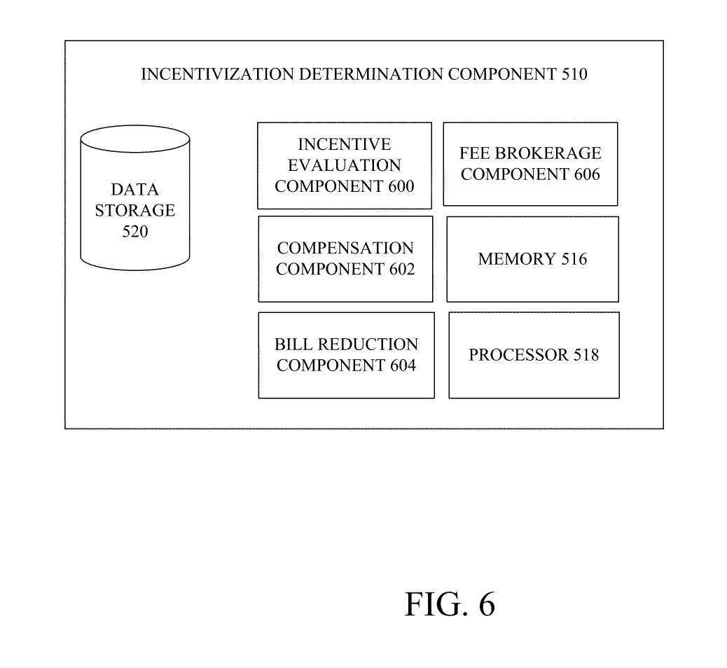

The incentivization determination component 510 can be described in greater detail with reference to FIG. 6. FIG. 6 illustrates an example block diagram of an incentivization determination component of the controller of FIG. 5 in accordance with one or more embodiments described herein. Repetitive description of like elements employed in respective embodiments of systems and/or apparatus described herein are omitted for sake of brevity.

As shown in FIG. 6, incentivization determination component 510 can include incentive evaluation component 600, compensation component 602, bill reduction component 604, fee brokerage component 606, memory 516, processor 518 and/or data storage 520. In various embodiments, one or more of incentive evaluation component 600, compensation component 602, bill reduction component 604, fee brokerage component 606, memory 516, processor 518 and/or data storage 520 can be electrically and/or communicatively coupled to one another to perform one or more functions of incentivization determination component 510. Repetitive description of like elements employed in respective embodiments of systems and/or apparatus described herein are omitted for sake of brevity.

Incentive evaluation component 600 can make a determination as to whether to generate incentivization information when controller 122 determines that recorded information should be requested. In one embodiment, incentive evaluation component 600 determines that incentivization information should be generated if controller 122 determines that recorded information should be requested and none of devices 102, 104, 106, 108, 110 (and/or recording components 111, 112, 114, 116, 118, 120) are in the environment or otherwise available to record the requested recorded information. In another embodiment, incentive evaluation component 600 can determine that incentivization information should be generated if additional views or recorded information beyond that already obtained by controller 122 is desired.

Compensation component 604 can determine a compensation to offer for a recording component to provide requested recorded information. Compensation component 604 can identify any number of different types of compensation to offer in exchange for recorded information. For example, the compensation component 604 can determine a monetary compensation or a points-based compensation or gift compensation to offer. In some embodiments, compensation component 604 can identify a specific type of compensation to offer for recorded information from a specific recording component based on compensation preferences associated with the recording component and/or based on whether recorded information has been provided (or not provided) in the past based on a particular type of compensation being offered.

Bill reduction component 606 can determine an amount by which a bill associated with the owner of the recording component can be reduced. In some embodiments, bill reduction component 606 can be communicatively coupleable to a network-based service that can provide information about one or more bills associated with the owner of the recording component and offer a discount or reduction relative to the amount of the bill.

Fee brokerage component 608 can broker one or more fees that a third-party provides to an owner of a recording component in exchange for recorded information requested by the third-party. In various embodiments, fee brokerage component 608 can facilitate negotiation of a fee requested by the owner to provide the recorded information, for example.

Turning back to FIG. 5, aggregation component 412 can aggregate recorded information recorded by one or more recording components and received by communication component 500. In various embodiments, aggregation component 412 can categorize, sort, order and/or label the received information. For example, the recorded information can be ordered based on the geographic location such that different recorded information from different recording components is aligned to create a panoramic image of the environment recorded. In some embodiments, aggregation component 412 can aggregate different recorded information from different devices to allow information processing component 414 to generate a multi-dimensional image or a panoramic image.

In some embodiments, the aggregation component 412 can aggregate one or more views to eliminate or reduce the likelihood of possible visual or audio occlusions for an event. For example, while one recorded image may provide an overview of an accident, other recorded images can specifically identify people (e.g., facial identification), vehicles (e.g., license plates), or other distinguishing marks (e.g., signs, branding, etc). In some embodiments, the people, vehicles or other distinguishing marks or images can be those that were previously indiscernible in the recorded image that provides the overview of the accident.

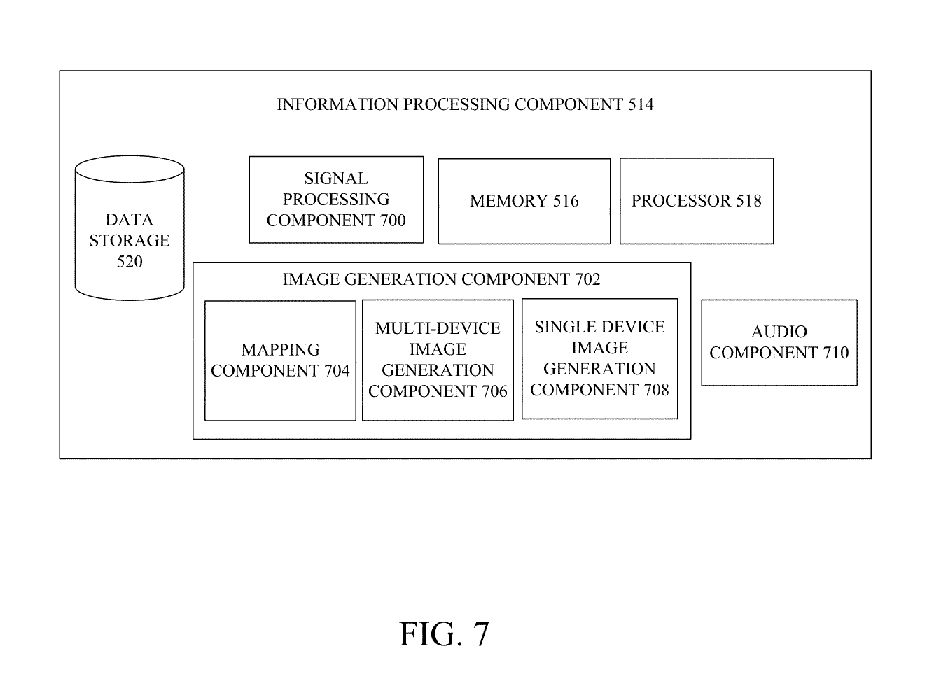

Information processing component 514 can be described in greater detail with reference to FIG. 7. FIG. 7 illustrates an example block diagram of an information processing component of controller 122 of FIG. 5 in accordance with one or more embodiments described herein. Information processing component 514 can include signal processing component 700, image generation component 702, mapping component 704, multi-device image generation component 706, single device image generation component 708, audio component 710, memory 516, processor 518 and/or data storage 520. In various embodiments, one or more of signal processing component 700, image generation component 702, mapping component 704, multi-device image generation component 706, single device image generation component 708 audio component 710, memory 516, processor 518 and/or data storage 520 can be electrically and/or communicatively coupled to one another to perform one or more functions of information processing component 514. Repetitive description of like elements employed in respective embodiments of systems and/or apparatus described herein are omitted for sake of brevity.

Signal processing component 700 can perform extrapolation, interpolation, filtering or any number of signal processing functions to process recorded information recorded by one or more of recording components 111, 112, 114, 116, 118, 120 and received by communication component 500. Mapping component 704 can generate a map or street view from recorded information recorded by one or more of recording components 111, 112, 114, 116, 118. Recorded information can be aggregated or combined when recorded information is received for the same street, environment or general area. In other embodiments, when recorded information is received from a single device, mapping component 704 can include the information for updating existing map information, generating a new map or the like. Accordingly, embodiments described herein can facilitate creation of new environment views (e.g., street views, park views, air views, water views) and/or updating of existing environment views.

Multi-device image generation component 706 can be configured to aggregate and/or combine video, images or other recorded information from different recording components 111, 112, 114, 116, 118 to generate multi-dimensional images (e.g., stereoscopic image, stereoscopic maps or environment views) in various embodiments. In some embodiments, multi-device image generation component 706 can be configured to combine information from different recording components 111, 112, 114, 116, 118 to generate a single image including components of recorded information received from recording components 111, 112, 114, 116, 118 (e.g., panoramic image, maps, environment views and/or tables including data from multiple devices).

Single device image generation component 708 can be configured to employ recorded information from a single one of recorded by one or more of recording components 111, 112, 114, 116, 118 to generate an image including recorded information received from the recorded component.

Audio component 710 can process audio recorded information from one or more of recording components 111, 112, 114, 116, 118. For example, record component 804 can record audio in an environment and transmit the audio recorded information to information processing component 514 of controller 122. Audio component 710 can filter and perform any number of different audio signal processing functions on the audio recorded information for clarity or overlay on a video, image, street or the like.

Turning back to FIG. 5, memory 516 can be a computer-readable storage medium storing computer-executable instructions and/or information for performing the functions described herein with reference to controller 122 (or any component of controller 122). For example, memory 516 can store computer-executable instructions that can be executed by processor 518 to perform communication, evaluation, decision-making or other types of functions executed by controller 122. Processor 518 can perform one or more of the functions described herein with reference to controller 122. For example, processor 518 can identify environment locations for which controller 122 would like to receive recorded information, process recorded information received to generate images, maps and/or text, evaluate location and time and date information for one or more devices to identify a device from which to request recorded information and/or any number of other functions described herein as performed by controller 122.

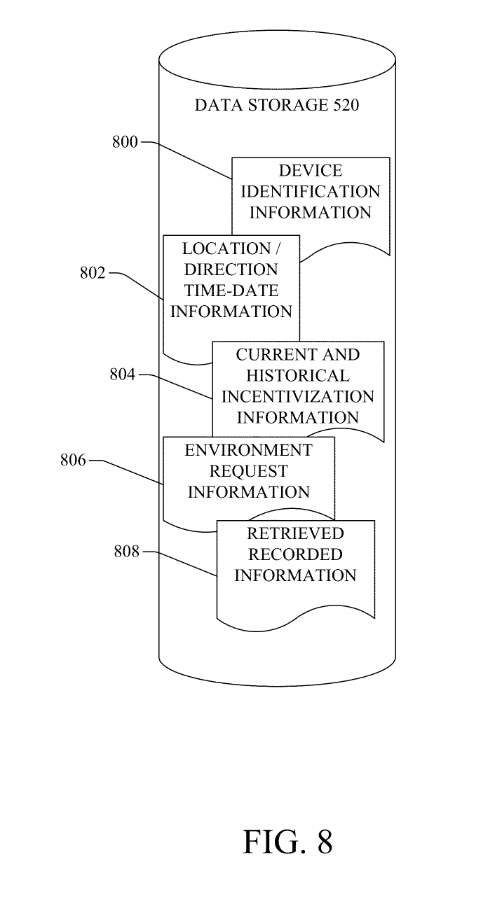

Data storage 520 can be described in greater detail with reference to FIG. 8. FIG. 8 illustrates an example block diagram of data storage of the controller of FIG. 5 in accordance with one or more embodiments described herein. Data storage 520 can be described in greater detail with reference to FIG. 8. As shown, data storage 520 can include device identification information 800, location/direction time-date information 802, current and historical incentivization information 804, environment request information 806 and/or retrieved recorded information 808. Repetitive description of like elements employed in respective embodiments of systems and/or apparatus described herein are omitted for sake of brevity.

In various embodiments, device identification information 800 can include information indicative of identifying information for one or more devices (e.g., devices 102, 104, 106, 108, 110) and/or one or more recording components (e.g., recording components 111, 112, 114, 116, 118, 120).

Location/direction time-date information 802 can include, but is not limited to, information about the geographical location of a device or recording component at one or more different points in time and/or on one or more different dates. For example, location/direction time-date information 802 can include information such as that shown in FIG. 2. Based on the device location/direction time-date information 802, controller 102 can identify one or more of devices 102, 104, 106, 108, 110 and/or one or more recording components 111, 112, 114, 116, 118, 120 in an environment of interest at a time or date of interest. In various embodiments, the time-date information can be indicative of a past time and/or date of interest.

Current and historical incentivization information 804 can include information about incentives offered and/or accepted by one or more different devices and/or recording components currently or in the past, conditions associated with certain offered and/or accepted conditions or the like. Environment request information 806 can include information indicative of an identifier of a device that has requested recorded information from controller 122 and/or an environment requested currently or in the past or the like. Retrieved recorded information 808 can include, but is not limited to, information previously-stored by one or more of recording components 111, 112, 114, 116, 118, 120 and received by controller 122 in response to a request from controller 122. For example, retrieved recorded information 808 can be different views of a particular environment of interest at a defined time and/or defined date. Controller 122 can employ information processing component 514 to generate an enhanced image of the environment employing the retrieved recorded information 808 received at controller 122.

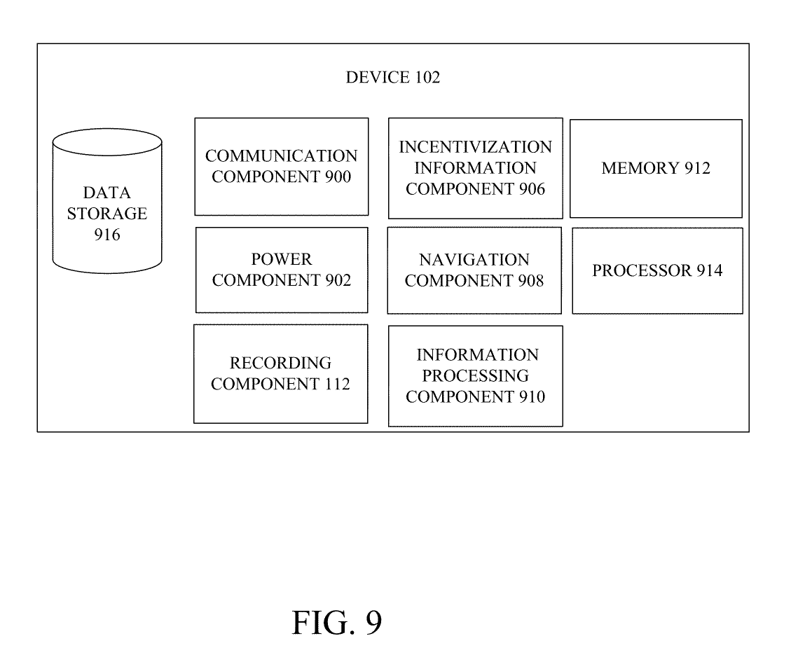

FIG. 9 illustrates an example block diagram of a device (e.g., device 102) that can facilitate environment views employing crowd sourced information in accordance with one or more embodiments described herein. As shown, device 102 can include communication component 900, power component 902, recording component 112, incentivization information component 906, navigation component 908, information processing component 910, memory 912, processor 914 and/or data storage 916. In various embodiments, one or more of communication component 900, power component 902, recording component 112, incentivization information component 906, navigation component 908, information processing component 910, memory 912, processor 914 and/or data storage 916 can be electrically and/or communicatively coupled to one another to perform one or more functions of device 102. Repetitive description of like elements employed in respective embodiments of systems and/or apparatus described herein are omitted for sake of brevity.

Communication component 900 can transmit and/or receive information to and/or from device 110. For example, in various embodiments, communication component 900 can transmit and/or receive any of a number of different types of information including, but not limited to, images, video, text, voice, data or the like. Communication component 900 can receive a message from controller 122 requesting recorded information recorded by recording component 112 and stored at data storage 916. The message can include information, for example, that identifies a time and/or date and/or geographic location at which recorded information was recorded. Communication component 900 can transmit to controller 122 the requested recorded information.

Power component 902 can be configured to turn on/off recording component 112 of device 102. For example, controller 122 can generate a message causing power component 902 to power on/off recording component 112. In various embodiments, for example, controller 122 can determine that recording component 112 and/or device 102 is positioned at a location and/or heading in a direction for which controller 122 would like to retrieve recorded information. As such, controller 122 can transmit, to communication component 900, information to cause power component 902 to turn on recording component 112. Similarly, in various embodiments, controller 122 can transmit, to communication component 900, information to cause power component 902 to turn off recording component 112.

Incentivization information component 906 can receive and/or process incentivization information generated by controller 122 and can determine whether to recorded information based on the incentivization information. For example, in various embodiments, incentivization information can include an offer of points or monetary compensation, a gift reward and/or a reduction in a bill to recorded information and/or travel to a location and recorded information.

Navigation component 908 can be configured to generate geographic location information device 102 to a location of interest to recorded information. Navigation component 908 can generate and/or output any number of different types of visual (e.g., maps, textual street directions, global positioning system coordinates), voice or other information to guide device 102 to a location of interest.

Information processing component 910 can perform one or more data processing and/or signal/image processing functions to manipulate, format, filter, aggregate or otherwise process the information recorded by recording component 112. In some embodiments, information processing component 910 can associate time, date and/or geographical location with portions of recorded information for identification by device 102 if controller 122 requests recorded information recorded at a particular time, on a particular date and/or at a particular geographical location.

In some embodiments, information processing component 910 can associate identifiers descriptive of the content of the recorded information. For example, the identifier can indicate content such as weather condition (e.g., rain, snow, thunderstorm, fog, sun glare), an event (e.g., vehicle collision, traffic condition, construction) or the like. Pattern recognition and/or other image and/or signal processing methods can be employed to generate the information for the identifiers. In some embodiments, information processing component 910 can process data retrieved from the environment including, but not limited to, measured humidity values, measured temperature values, measured visibility conditions).

Memory 912 can be a computer-readable storage medium storing computer-executable instructions and/or information for performing the functions described herein with reference to device 102 (or any component of device 102). For example, memory 912 can store computer-executable instructions that can be executed by processor 914 to perform communication, evaluation, decision-making or other types of functions executed by device 102. Processor 914 can perform one or more of the functions described herein with reference to device 102. For example, processor 914 can identify portions of recorded information stored in data storage 916 to be transmitted to controller 122. In other embodiments, processor 914 can evaluate incentivization information to determine whether such offerings are sufficient to cause device 102 to retrieve requested information, perform signal/image processing of recorded information or any number of other functions described herein as performed by device 102.

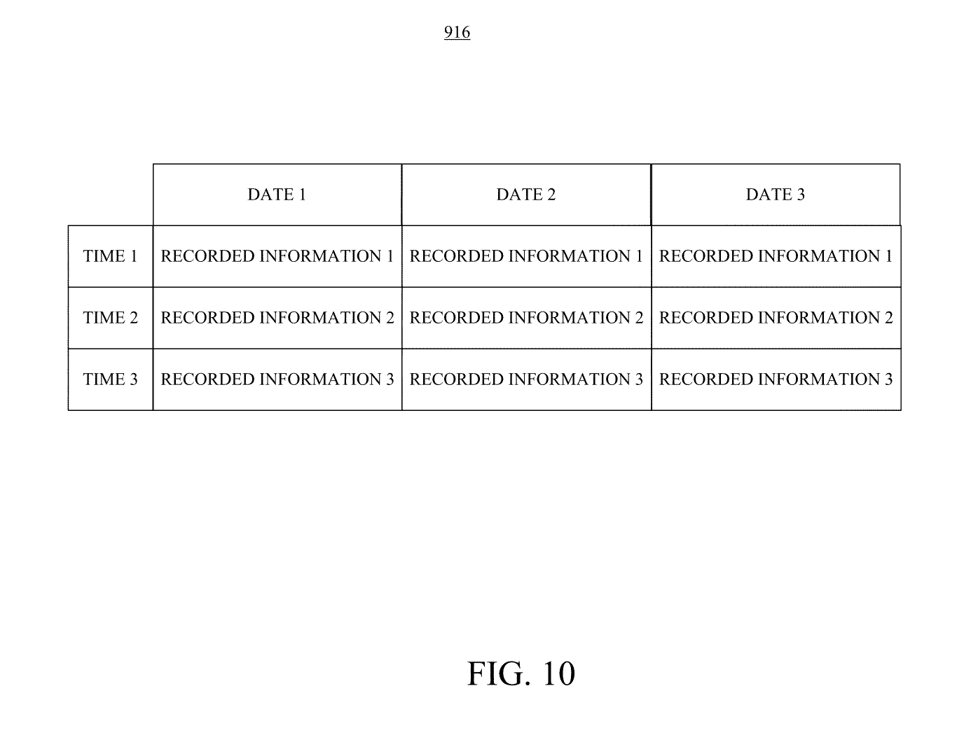

Data storage 916 can be described in greater detail with reference to FIG. 10. FIG. 10 illustrates an example block diagram of data storage of the device of FIG. 9 in accordance with one or more embodiments described herein. As shown, data storage 916 can include recorded information 900 and device identification information 902. In various embodiments, recorded information. Recorded information can be any number of different types of information recorded or measured by a recording component of device 102 including, but not limited to, images, video, data regarding aspects of weather (e.g., humidity, temperature). In various embodiments, as shown, recorded information can be stored such that the portions of recorded information recorded at different times and/or on different dates can be retrieved from recorded information. As such, data storage 916 can retrieve specified portions of previously-stored recorded information that can correspond to a particular location or environment of interest, a particular day, a particular time or the like. In some embodiments, recorded information can be stored with indicators of content recorded. For example, information depicting other cars can be stored with a car indicator while information depicting a thunderstorm/rain can be stored with a thunderstorm/rain indicator.

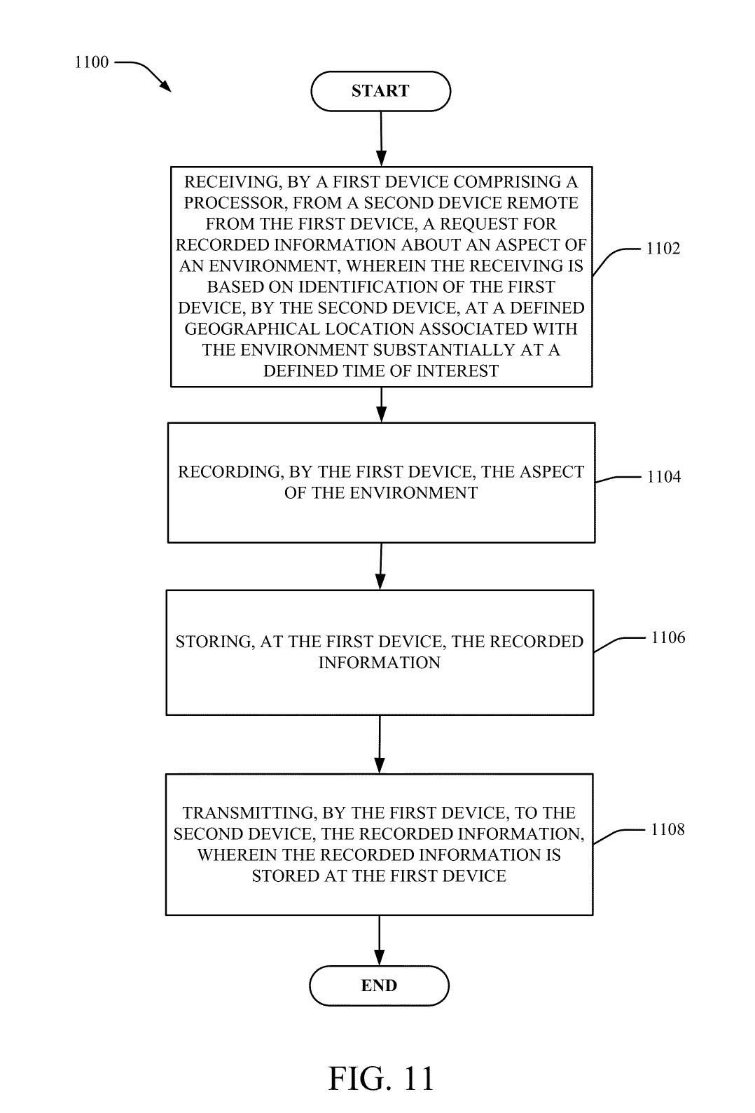

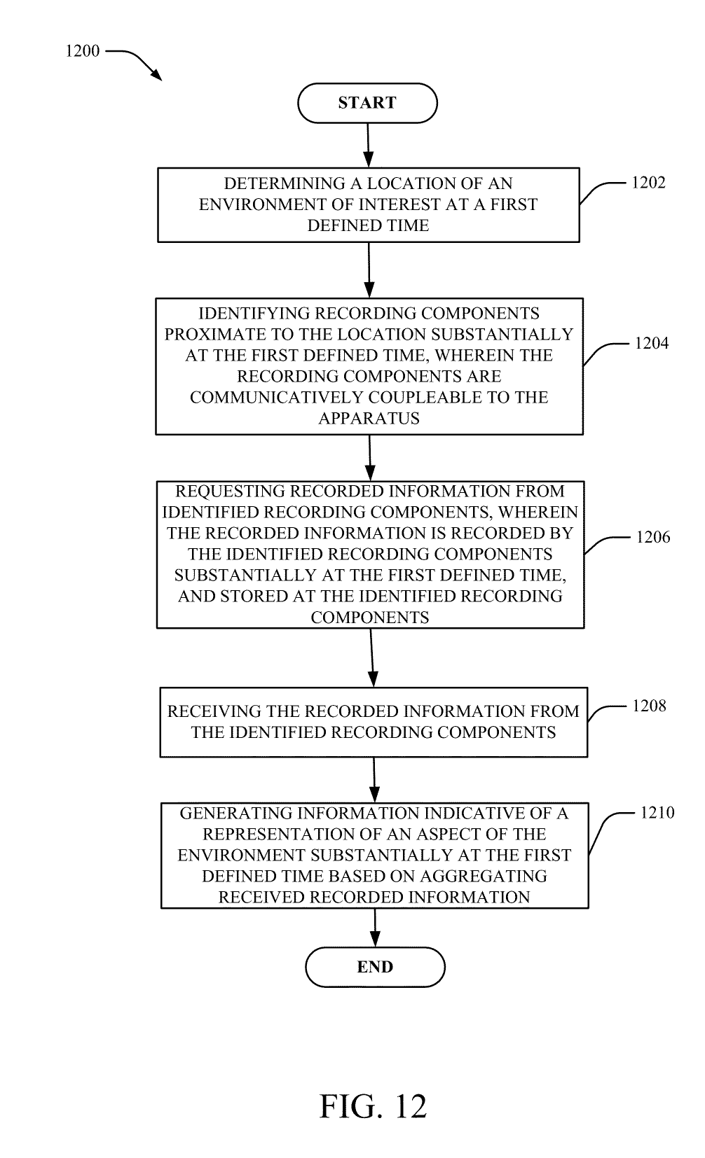

FIGS. 11 and 12 illustrate example flowcharts of methods that facilitate environment views employing crowd sourced information in accordance with one or more embodiments described herein.

Turning first to FIG. 11, at 1102, method 1100 can include receiving, by a first device comprising a processor, from a second device remote from the first device, a request for recorded information about an aspect of an environment. In some embodiments, the receiving is based on identification of the first device, by the second device, at a defined geographical location associated with the environment substantially at a defined time of interest. In some embodiments, although not shown, the receiving is further based on a geographical direction of travel of the first device.

At 1104, method 1100 can include recording, by the first device, the aspect of the environment. At 1106, method 1100 can include storing, at the first device, the recorded information. Accordingly, in some embodiments, recorded information can be stored locally at a device as opposed to being stored at a central repository that stores recorded information generated for a number of devices.

At 1108, method 1100 can include transmitting, by the first device, to the second device, the recorded information, wherein the recorded information is stored at the first device. In some embodiments, the recorded information requested is that which is generated substantially at the defined time of interest. The request for recorded information can also include a request to power on a recording component of the first device in some embodiments.

Turning now to FIG. 12, at 1202, method 1200 can include determining a location of an environment of interest at a first defined time. At 1204, method 1200 can include identifying recording components proximate to the location substantially at the first defined time, wherein the recording components are communicatively coupleable to the apparatus.

At 1206, method 1200 can include requesting recorded information from identified recording components, wherein the recorded information is recorded by the identified recording components substantially at the first defined time, and stored at the identified recording components.

At 1208, method 1200 can include receiving the recorded information from the identified recording components. At 1210, method 1200 can include generating information indicative of a representation of an aspect of the environment substantially at the first defined time based on aggregating received recorded information.

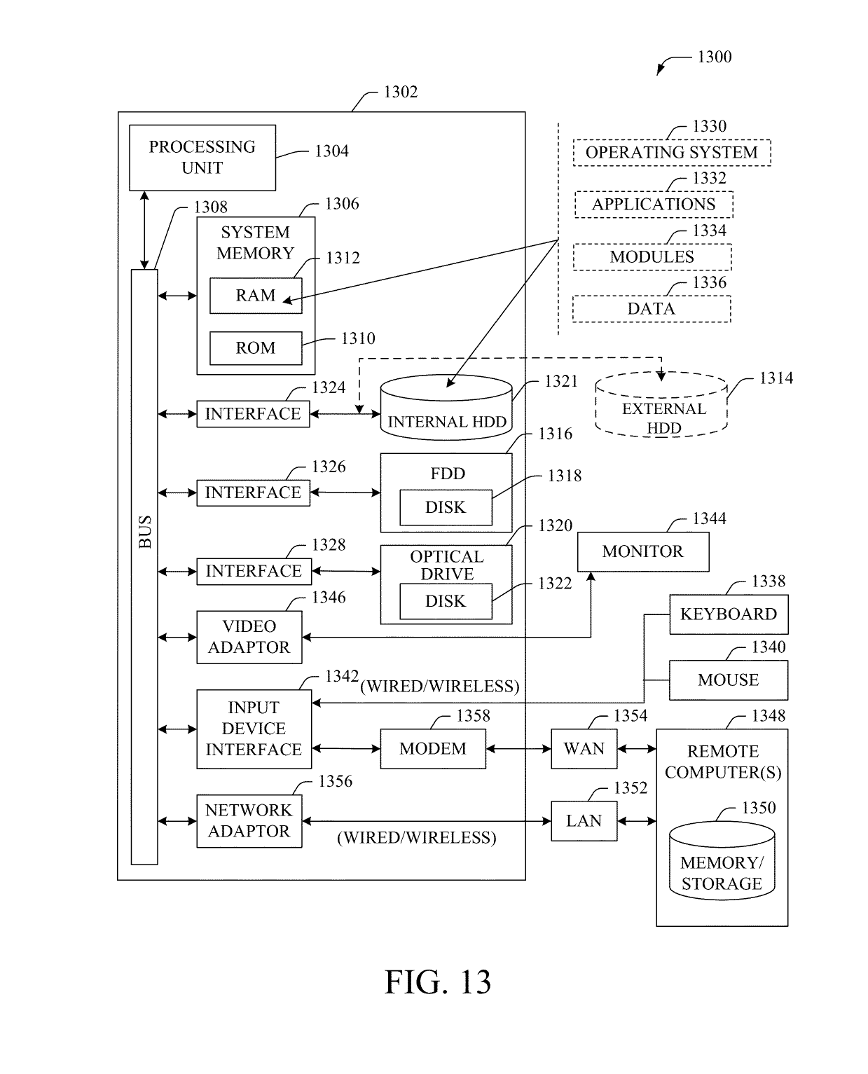

FIG. 13 illustrates a block diagram of a computer operable to facilitate environment views employing crowd sourced information in accordance with one or more embodiments described herein. For example, in some embodiments, the computer can be or be included within controller 122, devices 102, 104, 106, 108, 110, recording components 111, 112, 114, 116, 118, 120 (and/or components thereof).

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data. Tangible and/or non-transitory computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable media, is to be understood to exclude only propagating intangible signals per se as a modifier and does not relinquish coverage of all standard storage, memory or computer-readable media that are not only propagating intangible signals per se.

In this regard, the term “non-transitory” herein as applied to storage, memory or computer-readable media, is to be understood to exclude only propagating transitory signals per se as a modifier and does not relinquish coverage of all standard storage, memory or computer-readable media that are not only propagating transitory signals per se.

Communications media typically embody computer-readable instructions, data structures, program modules or other structured or unstructured data in a data signal such as a modulated data signal, e.g., a channel wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), which internal hard disk drive 1314 can also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1314, respectively. The interface 1324 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

A mobile device can enter commands and information into the computer 1302 through one or more wired/wireless input devices, e.g., a keyboard 1338 and a pointing device, such as a mouse 1340. Other input devices (not shown) can include a microphone, an infrared (IR) remote control, a joystick, a game pad, a stylus pen, touch screen or the like. These and other input devices are often connected to the processing unit 1304 through an input device interface 1342 that can be coupled to the system bus 1308, but can be connected by other interfaces, such as a parallel port, an IEEE 1394 serial port, a game port, a universal serial bus (USB) port, an IR interface, etc.

A monitor 1344 or other type of display device can be also connected to the system bus 1308 via an interface, such as a video adapter 1346. In addition to the monitor 1344, a computer typically includes other peripheral output devices (not shown), such as speakers, printers, etc.

The computer 1302 can operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1352 through a wired and/or wireless communication network interface or adapter 1356. The adapter 1356 can facilitate wired or wireless communication to the LAN 1352, which can also include a wireless AP disposed thereon for communicating with the wireless adapter 1356.

When used in a WAN networking environment, the computer 1302 can include a modem 1358 or can be connected to a communications server on the WAN 1354 or has other means for establishing communications over the WAN 1354, such as by way of the Internet. The modem 1358, which can be internal or external and a wired or wireless device, can be connected to the system bus 1308 via the input device interface 1342. In a networked environment, program modules depicted relative to the computer 1302 or portions thereof, can be stored in the remote memory/storage device 1350. It will be appreciated that the network connections shown are example and other means of establishing a communications link between the computers can be used.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a mobile device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing mobile device behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of mobile device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

Memory disclosed herein can include volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM) or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
identifying, by a first device comprising a processor, a second device of devices associated with respective recording components, wherein the identifying is based on geographic locations of the devices and a location of an environment of interest; and
transmitting, by the first device to a recording component of the respective recording components, a message indicative of a request for recorded information representing the location of the environment of interest, wherein the recording component is associated with the second device of the devices.

2. The method of claim 1, wherein the message further comprises incentivization information indicative of a reward to provide the recorded information.

3. The method of claim 2, wherein the second device is a mobile device and wherein the reward to provide the recorded information is a function of a travel distance between another location of the second device substantially at a time of the transmitting and the location of the environment of interest.

4. The method of claim 2, wherein the second device is a mobile device and wherein the reward to provide the recorded information is a function of an estimated travel difficulty for the second device to obtain the recorded information.

5. The method of claim 1, wherein, at the time of the transmitting, the second device is at another location remote from the location of the environment of interest.

6. The method of claim 1, further comprising:
receiving, by the first device, from a third device, a request for the recorded information.

7. The method of claim 6, further comprising:
brokering, by the first device, a fee between the second device and the third device for retrieval of the recorded information by the second device.

8. The method of claim 1, further comprising:
receiving, by the first device, from the recording component, the recorded information.

9. The method of claim 1, wherein the recording component comprises a camera.

10. The method of claim 1, wherein the recording component is configured to perform depth-sensing.

11. The method of claim 1, wherein the recording component comprises a measuring device configured to determine an aspect of weather at the location of the environment of interest.

12. A method, comprising:
receiving, by a first device comprising a processor, from a second device remote from the first device, a request for recorded information about an aspect of an environment, wherein the receiving is based on identification of the first device, by the second device, at a defined geographical location associated with the environment substantially at a defined time of interest; and
transmitting, by the first device, to the second device, the recorded information, wherein the recorded information is stored at the first device.

13. The method of claim 12, further comprising:
recording, by the first device, the aspect of the environment; and
storing, at the first device, the recorded information.

14. The method of claim 12, wherein the receiving is further based on a geographical direction of travel of the first device.

15. The method of claim 12, wherein the recorded information is generated substantially at the defined time of interest.

16. The method of claim 12, wherein the request for recorded information comprises a request to power on a recording component of the first device.

17. An apparatus, comprising:
a memory to store executable instructions; and
a processor, coupled to the memory, that facilitates execution of the executable instructions to perform operations, comprising:
determining a location of an environment of interest at a first defined time;
identifying recording components proximate to the location substantially at the first defined time, wherein the recording components are communicatively coupleable to the apparatus; and
requesting recorded information from identified recording components, wherein the recorded information is recorded by the identified recording components substantially at the first defined time, and stored at the identified recording components.

18. The apparatus of claim 17, wherein the operations further comprise:
receiving the recorded information from the identified recording components; and
generating information indicative of a representation of an aspect of the environment substantially at the first defined time based on aggregating received recorded information.

19. The apparatus of claim 17, wherein the operations further comprise:
transmitting information, at a second defined time, to cause the recording components to power on, wherein the transmitting the information to cause the recording components to power on is based on presence of the recording components in the environment substantially at the first defined time.

20. The apparatus of claim 19, wherein the second defined time is after the first defined time, and wherein locations of the recording components at times of the transmitting are distinct from the location of the environment of interest at the first defined time.
